(19) United States
(12) Patent Application Publication
(10) Pub. No.: US 2011/0008164 A1
(43) Pub. Date: Jan. 13, 2011

(54) WIND TURBINE

(75) Inventor: Walter M. Presz, JR., Wilbraham, MA (US)

Correspondence Address: FAY SHARPE LLP, 1228 Euclid Avenue, 5th Floor, The Halle Building, Cleveland, OH, 44115, US

(73) Assignee: FloDesign Wind Turbine Corporation

(21) Appl. No.: 12/779,545

(22) Filed: May 13, 2010

Related U.S. Application Data
(63) Continuation-in-part of application No. 12/054,050, filed on Mar. 24, 2008.
(60) Provisional application No. 60/919,588, filed on Mar. 23, 2007.
(60) Provisional application No. 61/177,901, filed on May 13, 2009.

(51) Int. Cl. F03D 1/04

(52) U.S. Cl. 415/211.2

(57) ABSTRACT

A shrouded wind turbine includes a shroud. The shroud is a ring airfoil and has a cross-sectional airfoil shape. The airfoil shape is optimized to minimize flow separation of the airstream passing inside the shroud.

This application is a continuation-in-part from U.S. patent application Ser. No. 12/054,050, filed Mar. 24, 2008, which claimed priority from U.S. Provisional Patent Application Ser. No. 60/919,588, filed Mar. 23, 2007. This application also claims priority to U.S. Provisional Patent Application Ser. No. 61/177,901, filed May 13, 2009. Applicants hereby fully incorporate the disclosure of these applications by reference in their entirety.

### BACKGROUND

The present disclosure relates to wind turbines, particularly wind turbines having one or more shrouds surrounding and enclosing the blades of the turbine. The shrouds can be considered to be a ring having a cross-sectional airfoil shape. The airfoil shape is selected to achieve certain specified results.

Conventional horizontal axis wind turbines (HAWTs) wind turbines have three blades and are oriented or pointed into the wind by computer controlled motors. These turbines typically require a supporting tower ranging from 60 to 90 meters (200-300 feet) in height. The blades generally rotate at a rotational speed of about 10 to 22 rpm, with tip speeds reaching over 200 mph. A gear box is commonly used to step up the speed to drive the generator, although some designs may directly drive an annular electric generator. Some turbines operate at a constant speed. However, more energy can be collected by using a variable speed turbine and a solid state power converter to interface the turbine with the generator. Although HAWTs have achieved widespread usage, their efficiency is not optimized. In particular, they will not exceed 59.3% efficiency, i.e., the Betz limit, in capturing the potential energy of the wind passing through it.

The blade of a HAWT typically has an airfoil shape that creates a lower pressure behind the blade as the blade passes through the air. This lower pressure creates a suction effect that follows the blade and creates a large wake to form behind the HAWT. This wake can reduce the amount of power captured by wind turbines downstream of the wind turbine creating the wake by up to 30%. To reduce the amount of power depletion, downstream turbines are often offset laterally from the upstream turbine, and are placed about 10 rotor diameters downstream of the upstream turbine as well. This displacement requires a large amount of land for a wind farm, where several wind turbines are placed in a single location.

Attempts have been made to try to increase wind turbine performance by placing a shroud or diffuser around the blades of the wind turbine. See, e.g., U.S. Pat. No. 7,218,011 to Hiel; U.S. Pat. No. 4,204,799 to de Geus; U.S. Pat. No. 4,075,500 to Oman; and U.S. Pat. No. 6,887,031 to Tocher. However, as yet, none have been successful enough to have entered the marketplace.

Desirably, a properly designed shroud causes the oncoming flow to speed up as it is concentrated into the center of the shroud. This increased flow speed should cause more force on the turbine blades and subsequently higher levels of power extraction. To achieve such increased power and efficiency, it is necessary to closely coordinate the aerodynamic designs of the shroud and the turbine blades with the sometimes highly variable incoming fluid stream velocity levels. Such aerodynamic design considerations also play a significant role on the subsequent impact of flow turbines on their surroundings, and the productivity level of wind farm designs.

FIG. 1 is a side cross-sectional diagram illustrating a particular aerodynamic phenomenon called “diffuser stall” that has been the root of many of the problems with shrouded wind turbines. This occurs when the airstream separates from the wall of the shroud or diffuser before passing out of the turbine, and causes recirculation of the air. Increasing the length of the diffuser will help solve this problem, but has the disadvantage of increasing the weight and the cost of the resulting diffuser. Here, the wind turbine 10 includes a diffuser shroud 20 and energy extraction equipment 12 located within the diffuser shroud. Here, the energy extraction equipment is shown as having propeller blades 14 and a center body or nacelle 16, and is located along centerline 18. The nacelle contains the gearbox, generator, and electronics necessary to operate the wind turbine. As shown here, the diffuser shroud separates incoming free air into two different streams, one stream 30 passing through the diffuser shroud 20 and the other stream 40 passing outside the diffuser shroud. The energy extraction equipment removes energy from the airstream 30, resulting in a pressure drop behind the equipment 12. Desirably, the boundary airstream 30 passing through/inside the diffuser shroud 20 remains attached to the diffuser shroud. However, in diffuser stall, the boundary airstream detaches from the diffuser shroud 20, as indicated by reference numeral 32. Put another way, flow separation occurs at a point before the airstream has reached the trailing edge 22 of the diffuser shroud 20. As a result, the airstream is recirculated in the diffuser shroud 20, instead of exiting the diffuser shroud.

### BRIEF DESCRIPTION

Disclosed herein are shrouded wind turbines having a shroud. The shroud has an airfoil shape that produces circulation of an airstream through the shroud and minimizes flow separation. Desirably, the airfoil shape also minimizes volume growth of the shroud from the inlet to the outlet of the shroud.

A mixer/ejector wind turbine system (referenced herein as a “MEWT”) for generating power is disclosed that combines fluid dynamic ejector concepts, advanced flow mixing and control devices, and an adjustable power turbine. In some embodiments or versions, the MEWT is an axial flow turbine comprising, in order going downstream: an aerodynamically contoured turbine shroud having an inlet; a ring of stators within the shroud; an impeller having a ring of impeller blades “in line” with the stators; a mixer, associated with the turbine shroud, having a ring of mixing lobes extending downstream beyond the impeller blades; and an ejector comprising the ring of mixing lobes and a mixing shroud extending downstream beyond the mixing lobes. The turbine shroud, mixer and ejector are designed and arranged to draw the maximum amount of wind through the turbine and to minimize impact upon the environment (e.g., noise) and upon other power turbines in its wake (e.g., structural or productivity losses). Unlike existing wind turbines, the preferred MEWT contains a shroud with advanced flow mixing and control devices such as lobed or slotted mixers and/or one or more ejector pumps. The mixer/ejector pump presented is much different than used heretofore since in the disclosed wind turbine, the high energy air flows into the ejector inlets, and outwardly surrounds, pumps and mixes with the low energy air exiting the turbine shroud.

Disclosed in embodiments is a shrouded horizontal axis wind turbine, comprising: an impeller; and a turbine shroud surrounding the impeller, the turbine shroud having a cross-sectional airfoil shape, the airfoil shape being selected so that flow separation occurs at a trailing edge of the turbine shroud.

The airfoil shape may be a NACA 4-series, 5-series, 1-series, 6-series, or 7-series airfoil. The turbine shroud may further comprise mixing lobes on a trailing edge thereof. If desired, an ejector shroud can also be used, wherein an exit end of the turbine shroud extends into an inlet end of the ejector shroud. The ejector shroud itself may have a cross-sectional airfoil shape selected so that flow separation occurs at a trailing edge of the ejector shroud.

Also disclosed in embodiments is a shrouded horizontal axis wind turbine, comprising: an impeller; a turbine shroud surrounding the impeller, the turbine shroud having a cross-sectional airfoil shape, the airfoil shape being selected so that flow separation occurs at a trailing edge of the turbine shroud; and an ejector shroud having an inlet end, wherein an exit end of the turbine shroud extends into the inlet end of the ejector shroud; and wherein the ejector shroud has a cross-sectional airfoil shape, the airfoil shape being selected so that flow separation occurs at a trailing edge of the ejector shroud.

These and other non-limiting features or characteristics of the present disclosure will be further described below.

### BRIEF DESCRIPTION OF THE DRAWINGS

The following is a brief description of the drawings, which are presented for the purposes of illustrating the disclosure set forth herein and not for the purposes of limiting the same.

FIG. 1 is a side cross-sectional view of a shrouded wind turbine illustrating diffuser stall.

FIG. 2 is an exploded view of a first exemplary embodiment or version of a MEWT of the present disclosure.

FIG. 3 is a front perspective view of FIG. 2 attached to a support tower.

FIG. 4 is a front perspective view of a second exemplary embodiment of a MEWT, shown with a shrouded three bladed impeller.

FIG. 5 is a rear view of the MEWT of FIG. 4.

FIG. 6 is a cross-sectional view taken along line 6-6 of FIG. 5.

FIG. 7 is a perspective view of another exemplary embodiment of a wind turbine of the present disclosure having a pair of wing-tabs for wind alignment.

FIG. 8 is a front perspective view of another exemplary embodiment of a MEWT of the present disclosure. Here, both the turbine shroud and the ejector shroud have mixing lobes on their trailing edges.

FIG. 9 is a rear perspective view of the MEWT of FIG. 8.

FIG. 10 is a front perspective view of another exemplary embodiment of a MEWT according to the present disclosure.

FIG. 11 is a side cross-sectional view of the MEWT of FIG. 10 taken through the turbine axis.

FIG. 12 is a smaller view of FIG. 11.

FIG. 12A and FIG. 12B are magnified views of the mixing lobes of the MEWT of FIG. 10.

FIG. 13 is a cross-sectional view of an airfoil, with oncoming air from the left.

FIG. 14 is a cross-sectional view of an airfoil, with oncoming air from the right.

FIG. 15 is the airfoil of FIG. 14, with certain lines removed for clarity.

FIG. 16 is a cross-sectional view of a ring airfoil shroud without mixer lobes.

FIG. 17 is a cross-sectional view of a ring airfoil shroud with mixer lobes.

FIG. 18 is a cross-sectional view of a ring airfoil shroud with mixer lobes that can move or switch between two angles of attack.

FIGS. 19-23 show airfoils having differing amounts of camber.

FIG. 24 is a graph showing the cross-section of the NACA 7412 airfoil.

FIG. 25 is a perspective view of the partially completed skeletons of a turbine shroud and ejector shroud of an exemplary wind turbine of the present disclosure.

FIG. 26 is a perspective view of the skeletons of FIG. 25, illustrating a portion of the skins attached to the exteriors of the two shroud skeletons.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

A Mixer-Ejector Power System (MEPS) provides a unique and improved means of generating power from wind currents. A MEPS includes:
a primary shroud containing a turbine or bladed impeller, similar to a propeller, which extracts power from the primary stream; and
a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”).

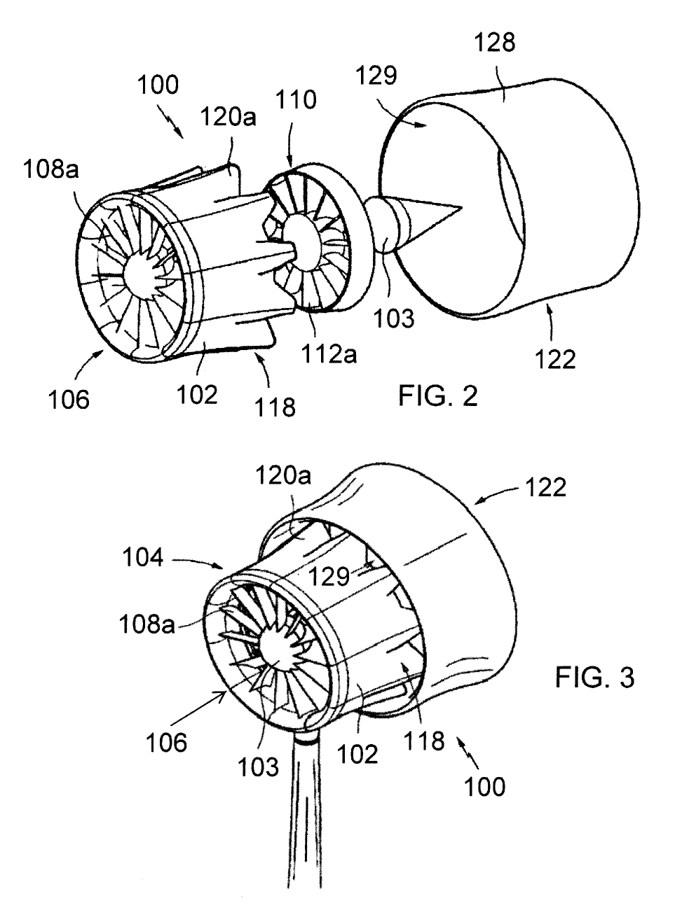

Referring to FIG. 2 and FIG. 3, the MEWT 100 is an axial flow turbine with:

a) an aerodynamically contoured turbine shroud 102;

b) an aerodynamically contoured center body 103 within and attached to the turbine shroud 102;

c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
i) the stator vanes 108a are mounted on the center body 103;
ii) the rotor blades 112a are attached and held together by inner and outer rings or hoops mounted on the center body 103;

d) a mixer indicated generally at 118 having a ring of mixer lobes 120a on a terminus region (i.e., end portion) of the turbine shroud 102, wherein the mixer lobes 120a extend downstream beyond the rotor blades 112a; and,

e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 3, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-3.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety. The MEWT should be considered to be a horizontal axis wind turbine as well.

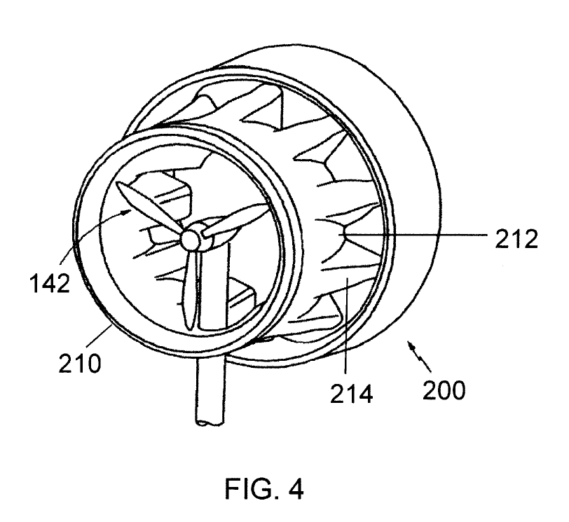

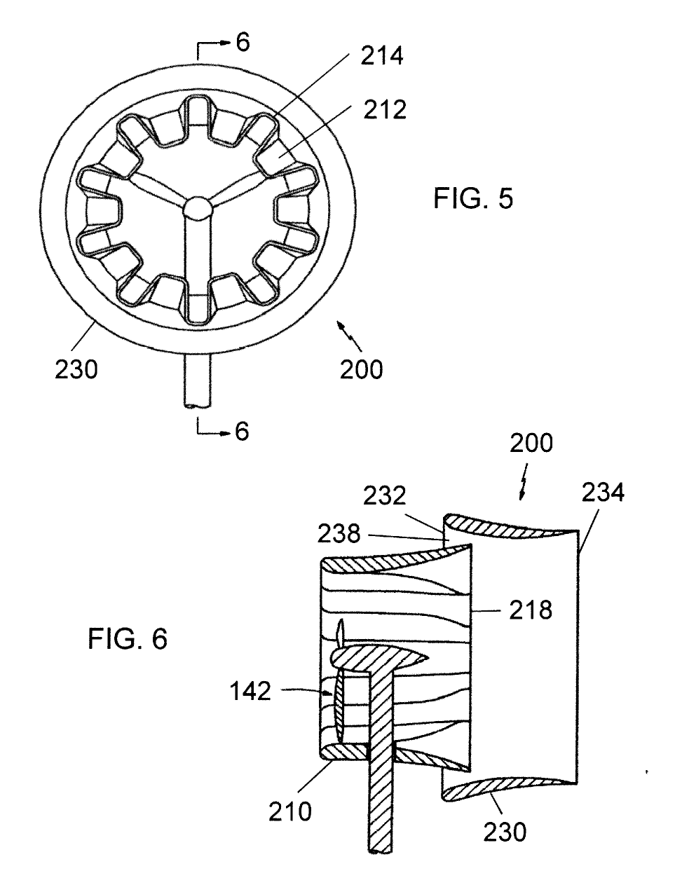

FIGS. 4-6 show a second exemplary embodiment of a shrouded wind turbine 200. The turbine 200 uses a propeller-type impeller 142 instead of the rotor/stator assembly as in FIG. 2 and FIG. 3. In addition, the mixing lobes can be more clearly seen in this embodiment. The turbine shroud 210 has two different sets of mixing lobes. Referring to FIG. 4 and FIG. 5, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 is shown with 10 low energy mixing lobes. The high energy mixing lobes alternate with the low energy mixing lobes around the trailing edge of the turbine shroud 210. From the rear, as seen in FIG. 5, the trailing edge of the turbine shroud may be considered as having a circular crenellated shape. The term “crenellated” or “castellated” refers to this general up-and-down or in-and-out shape of the trailing edge.

As seen in FIG. 6, the entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

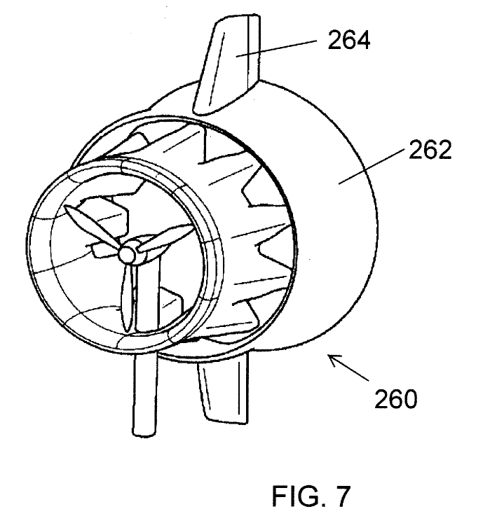

As shown in FIG. 7, another exemplary embodiment of a wind turbine 260 may have an ejector shroud 262 that has internal ribs shaped to provide wing-tabs or fins 264. The wing-tabs or fins 264 are oriented to facilitate alignment of the wind turbine 260 with the incoming wind flow to improve energy or power production.

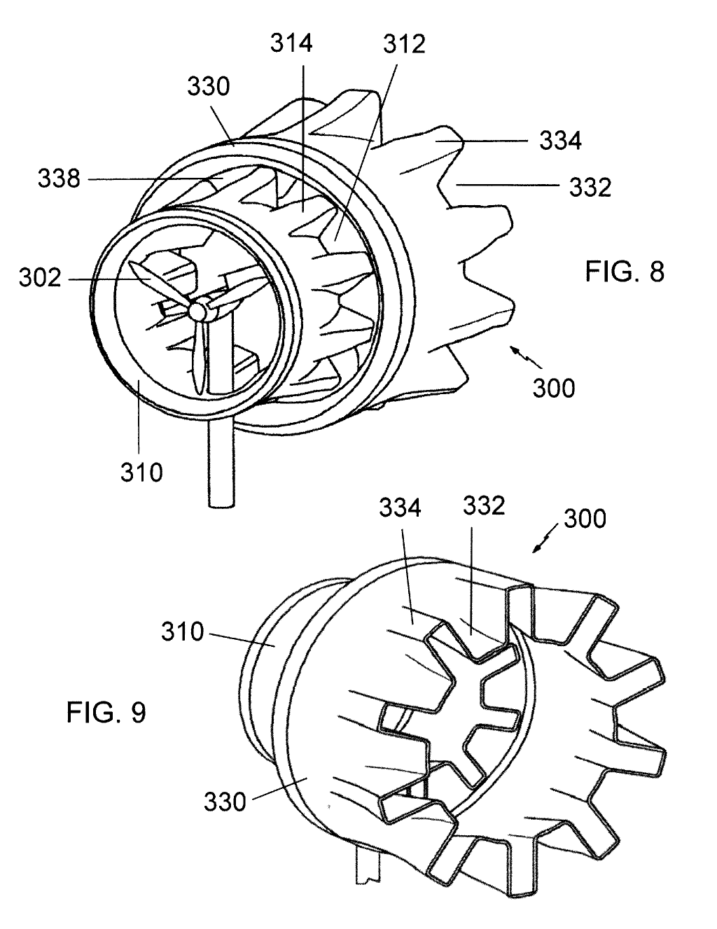

FIG. 8 and FIG. 9 illustrate another exemplary embodiment of a MEWT. The turbine 400 again uses a propeller-type impeller 302. The turbine shroud 310 has two different sets of mixing lobes. A set of high energy mixing lobes 312 extend inwards toward the central axis of the turbine. A set of low energy mixing lobes 314 extend outwards away from the central axis. In addition, the ejector shroud 330 is provided with mixing lobes on a trailing edge thereof. Again, two different sets of mixing lobes are present. A set of high energy mixing lobes 332 extend inwards toward the central axis of the turbine. A set of low energy mixing lobes 334 extend outwards away from the central axis. As seen in FIG. 9, the ejector shroud is shown here with 10 high energy mixing lobes and 10 low energy mixing lobes. The high energy mixing lobes alternate with the low energy mixing lobes around the trailing edge of the turbine shroud 330. Again, the trailing edge of the ejector shroud may be considered as having a circular crenellated shape.

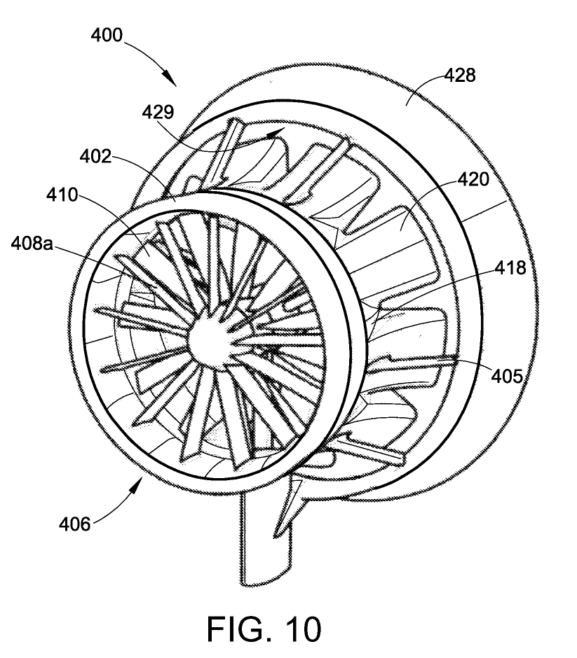

FIGS. 10-12 illustrate another exemplary embodiment of a MEWT. The MEWT 400 in FIG. 10 has a stator 408a and rotor 410 configuration for power extraction. A turbine shroud 402 surrounds the rotor 410 and is supported by or connected to the blades or spokes of the stator 408a. The turbine shroud 402 has the cross-sectional shape of an airfoil with the suction side (i.e. low pressure side) on the interior of the shroud. Put another way, the turbine shroud 402 is a ring airfoil. In other words, the turbine shroud forms a ring or a cylinder, and that ring, when viewed in cross-section, has an airfoil shape.

An ejector shroud 428 is coaxial with the turbine shroud 402 and is supported by connector members 405 extending between the two shrouds. An annular area is thus formed between the two shrouds. The rear or downstream end of the turbine shroud 402 is shaped to form two different sets of mixing lobes 418, 420. High energy mixing lobes 418 extend inwardly towards the central axis of the turbine shroud 402; and low energy mixing lobes 420 extend outwardly away from the central axis.

Free stream air indicated generally by arrow 406 passing through the stator 408a has its energy extracted by the rotor 410. High energy air indicated by arrow 429 bypasses the shroud 402 and stator 408a and flows over the turbine shroud 402 and directed inwardly by the high energy mixing lobes 418. The low energy mixing lobes 420 cause the low energy air exiting downstream from the rotor 410 to be mixed with the high energy air 429.

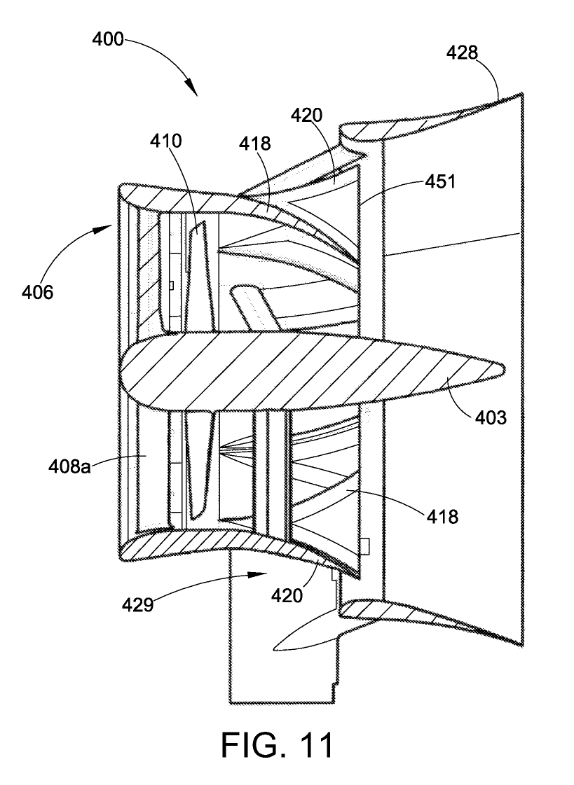

Referring to FIG. 11, the center nacelle 403 and the trailing edges of the low energy mixing lobes 420 and the trailing edge of the high energy mixing lobes 418 are shown in the axial cross-sectional view of the turbine of FIG. 10. The ejector shroud 428 is used to direct inwardly or draw in the high energy air 429. Optionally, nacelle 403 may be formed with a central axial passage therethrough to reduce the mass of the nacelle and to provide additional high energy turbine bypass flow.

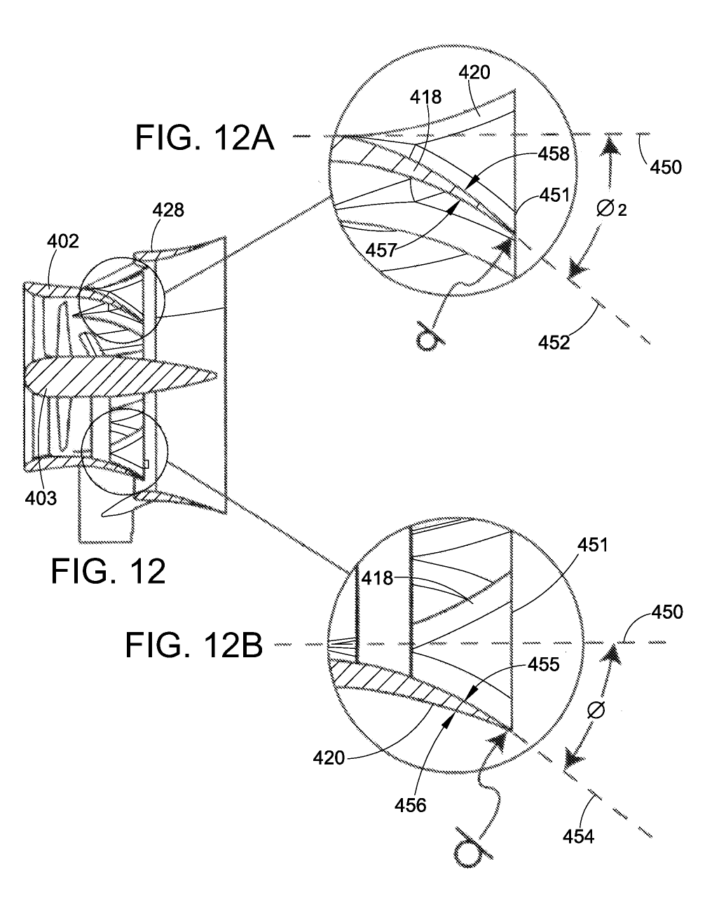

In FIG. 12A, a tangent line 452 is drawn along the interior trailing edge indicated generally at 457 of the high energy mixing lobe 418. A rear plane 451 of the turbine shroud 402 is present. A line 450 is formed normal to the rear plane 451 and tangent to the point where a low energy mixing lobe 420 and a high energy mixing lobe 418 meet. An angle Ø₂ is formed by the intersection of tangent line 452 and line 450. This angle Ø₂ is between 5 and 65 degrees. Put another way, a high energy mixing lobe 418 forms an angle Ø₂ between 5 and 65 degrees relative to the turbine shroud 402.

In FIG. 12B, a tangent line 454 is drawn along the interior trailing edge indicated generally at 455 of the low energy mixing lobe 420. An angle Ø is formed by the intersection of tangent line 454 and line 450. This angle Ø is between 5 and 65 degrees. Put another way, a low energy mixing lobe 420 forms an angle Ø between 5 and 65 degrees relative to the turbine shroud 402.

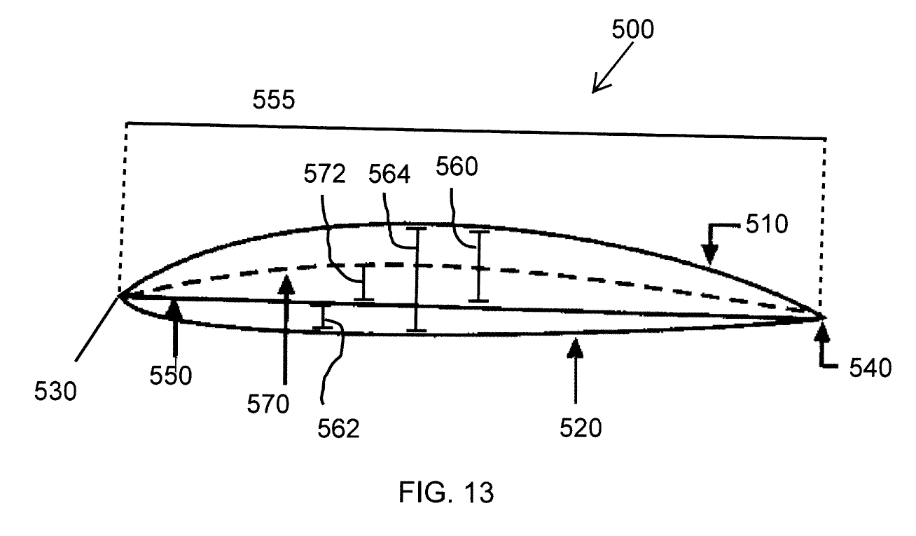

FIG. 13 is a cross-sectional view of a shroud, showing the airfoil shape, with the oncoming airstream coming from the left. This shroud may correspond to either the turbine shroud or the ejector shroud. Generally speaking, the airfoil 500 has an upper surface 510 and a lower surface 520. The airfoil shape causes the air flowing over the upper surface to have a higher average velocity than the air flowing over the lower surface. By Bernoulli's principle, the pressure adjacent the upper surface is lower than the pressure adjacent the lower surface. The upper surface 510 of FIG. 13 would be on the interior of the turbine shroud 402 of FIG. 9.

Some terminology relevant to describing the shape of the airfoil can be explained with reference to FIG. 13. The “leading edge” 530 is the portion of the airfoil that meets the airstream first. The “trailing edge” 540 is the portion of the airfoil where air flowing over the upper surface 510 meets the air flowing over the lower surface 520. The “chord line” 550 is an imaginary straight line drawn through the airfoil from the leading edge 530 to the trailing edge 540. The length 555 of the chord line 550 is referred to simply as the “chord”. The “upper camber” refers to the curve of the upper surface, and can be measured as the distance 560 normal (i.e. 90° or perpendicular) from the chord line to the upper surface as a function of the distance from the leading edge. The “lower camber” refers to the curve of the lower surface, and can be measured as the distance 562 normal from the chord line to the lower surface as a function of the distance from the leading edge. The “maximum thickness” 564 is the maximum distance between the upper surface and the lower surface. The “mean camber line” is a line 570 that is midway between the upper and lower surfaces. The mean camber line can be located by inscribing a series of circles inside the airfoil; the mean camber line is the line made by joining the centers of all of the circles. The “camber” refers to the curved shape of the airfoil, and can be measured as the distance 572 between the chord line 550 and the mean camber line 570 as a function of the distance from the leading edge. Negative camber is possible when the mean camber line lies below the chord line.

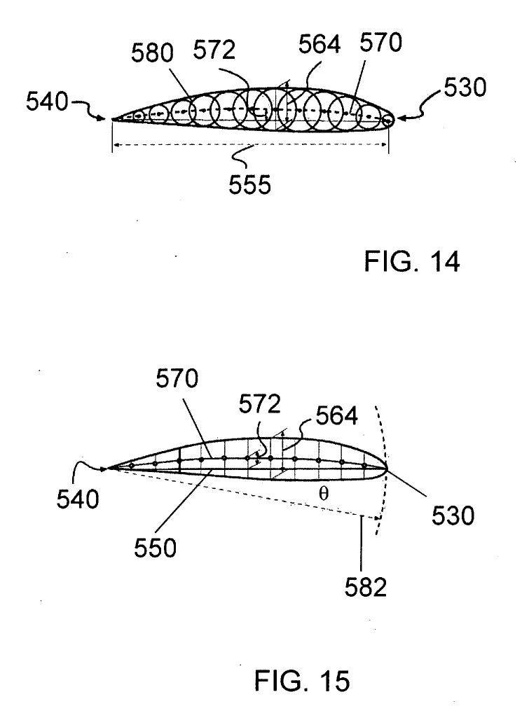

FIGS. 14 and 15 further illustrate the terminology. Again, the chord line 550 is a straight line between the leading edge 530 and the trailing edge 540, and has a chord 555. A series of circles 580 is inscribed inside the airfoil, and the mean camber line 570 is formed by joining the center of all of the circles. The camber 572 is the distance between the chord line 550 and the mean camber line 570 as a function of the distance from the leading edge. The maximum thickness 564 is the maximum distance between the upper surface and the lower surface, and can be considered to be the largest diameter of the inscribed circles. FIG. 15 removes the circles. The angle of attack is determined by the angle θ made between the chord line 550 and the oncoming airstream 582 (here coming from the right), and the vertex being the trailing edge 540.

The airfoil shape of the turbine shroud and the ejector shroud can be controlled to improve the aerodynamics of the overall wind turbine. By optimizing the shape of the airfoil, higher airstream velocities can be produced at the location of the turbine itself to obtain maximum energy extraction from the airstream and maximum energy production from the turbine. The shape of the leading edge, the angle of attack (i.e. the angle between the chord line and the incoming airstream), the camber of the airfoil, and the length of the airfoil can be controlled to achieve these results.

As previously discussed in reference to FIGS. 10-12, the turbine shroud 402 has the cross-sectional shape of an airfoil with the suction side (i.e. low pressure side) on the interior of the shroud. Air circulation through the shroud 402 is aided and maintained by this low-pressure region within the shroud 402. The Kutta-Joukowski theorem describes fluid circulation around a cylinder and the lift that is generated as a result. The Kutta condition is that the rear stagnation point on the airfoil is located at the trailing edge. The optimized airfoil shape of the present disclosure meets the Kutta condition, so that there is circulation of air through the shroud without diffuser stall. The airfoil shape allows for a pressure drop within the shroud while keeping the airstream attached to the shroud through the length of the shroud.

Referring to FIG. 11, the airfoil shape of the shroud may have a smooth trailing edge, as seen in the ejector shroud 428, or can have mixing lobes, as in the turbine shroud 402. The addition of mixing lobes, particularly to the turbine shroud 402, can permit the airfoil shape of the shroud to have more camber and a greater angle of attack without flow separation. It should also be noted that the airfoil shape of the shroud is asymmetrical.

In particular, the airfoil shape of the turbine shroud and ejector shroud are produced using airfoil templates named according to National Advisory Committee for Aerodynamics (NACA) standards. It is believed that several thousand such airfoil templates exist. The nomenclature of several NACA series are defined by various designations, as explained below.

The NACA 4-digit series airfoils are described by a four-digit number. The first digit describes maximum camber as a percentage of the chord. The second digit describes the distance of maximum camber from the airfoil leading edge in tens of percents of the chord. The last two digits describe the maximum thickness of the airfoil as percent of the chord. For example, the NACA 2412 airfoil has a maximum camber of 2% of the chord (0.02 chords) at a location 40% of the chord (0.4 chords) from the leading edge. The maximum thickness of the airfoil is 12% of the chord.

The NACA 5-digit series airfoils are described by a five-digit number, and describe airfoils having more complex shapes than those of the NACA 4-digit series. In the 5-series, the first digit, when multiplied by 0.15, gives the designed lift coefficient (C_{L}). The second and third digits, when taken together and divided by 2, give the distance of maximum camber from the leading edge as a percentage of the chord. The fourth and fifth digits, taken together, give the maximum thickness of the airfoil, as a percentage of the chord. For example, the NACA 12045 airfoil would give an airfoil with a lift coefficient of 0.15 and a maximum thickness of 45% of the chord, located at 10% of the chord.

The NACA 1-series airfoils are characterized by small leading edge radii, comparatively large trailing-edge angles, and slightly higher critical speeds for a given thickness ratio. These airfoils have proven useful for propellers. The 1-series airfoils are described by five digits. The first digit is always 1, to indicate the series. The second digit provides the distance of the minimum pressure area from the leading edge, in tens of percents of the chord. A hyphen follows the second digit. The third digit describes the lift coefficient in tenths. The fourth and fifth digits, taken together, give the maximum thickness of the airfoil, as a percentage of the chord. For example, the NACA 16-123 airfoil has a minimum pressure 60% of the chord away from the leading edge, a lift coefficient of 0.1, and a maximum thickness of 23% of the chord.

The NACA 6-series airfoils are intended to maximize laminar flow, and are designated with a six-digit number and a mean line designation. The first digit is always 6, to indicate the series. The second digit provides the distance of the minimum pressure area from the leading edge, in tens of percents of the chord. The third digit, which is usually indicated as a subscript, gives the range of lift coefficient in tenths above and below the design lift coefficient in which favorable pressure gradients exist on both surfaces. A hyphen follows the third digit. The fourth digit describes the design lift coefficient in tenths. The fifth and sixth digits, taken together, give the maximum thickness of the airfoil, as a percentage of the chord. The mean line designation is the phrase “a=” along with a fraction that indicates the point at which a uniform clockwise loading exists from the leading edge to the point, and a linearly decreasing load exists from the point to the trailing edge. For example, the NACA 65₃-218, a=0.5 airfoil has the minimum pressure area 0.1 chords from the leading edge, maintains low drag 0.2 above and below the lift coefficient of 0.2, has a maximum thickness of 18% of the chord, and maintains laminar flow over 50% of the chord.

The NACA 7-series airfoils have a greater extent of possible laminar flow by allowing independent identification of the low pressure areas on the upper and lower surfaces of the airfoil. The airfoil is designated with a seven-character name. The first three characters are digits, the fourth character is a letter, and the last three characters are digits.

The first digit is always 7, to indicate the series. The second digit provides the distance of the minimum pressure area on the upper surface from the leading edge, in tens of percents of the chord. The third digit provides the distance of the minimum pressure area on the lower surface from the leading edge, in tens of percents of the chord. The letter refers to a standard profile from the earlier NACA series. The fourth digit (fifth character) describes the design lift coefficient in tenths. The fifth and sixth digits, taken together, give the maximum thickness of the airfoil, as a percentage of the chord. A mean line designation, like that described for the 6-series, may follow the seven-character name. If no mean line designation is provided, the default is a=1. For example, the NACA 747A315 airfoil has the area of minimum pressure 40% of the chord back on the upper surface and 70% of the chord back on the lower surface, uses the standard “A” profile, has a lift coefficient of 0.3, and has a maximum thickness of 15% of the chord.

The various NACA series airfoils are well-known in the art, and several programs exist that can translate the various airfoil designations into a specific airfoil shape.

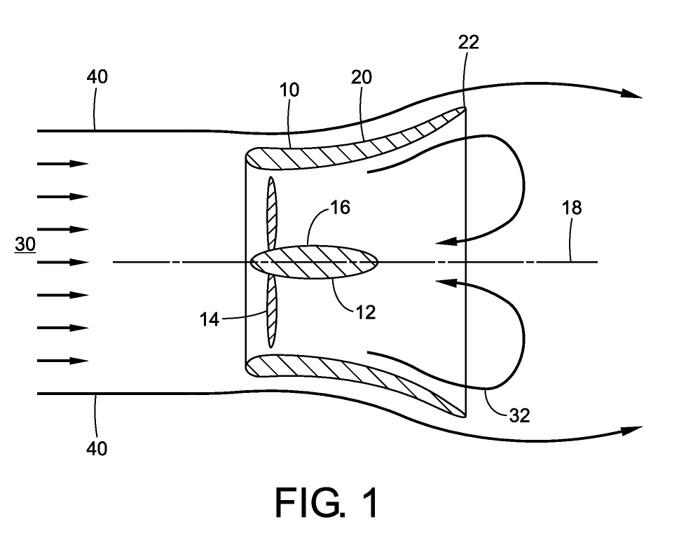

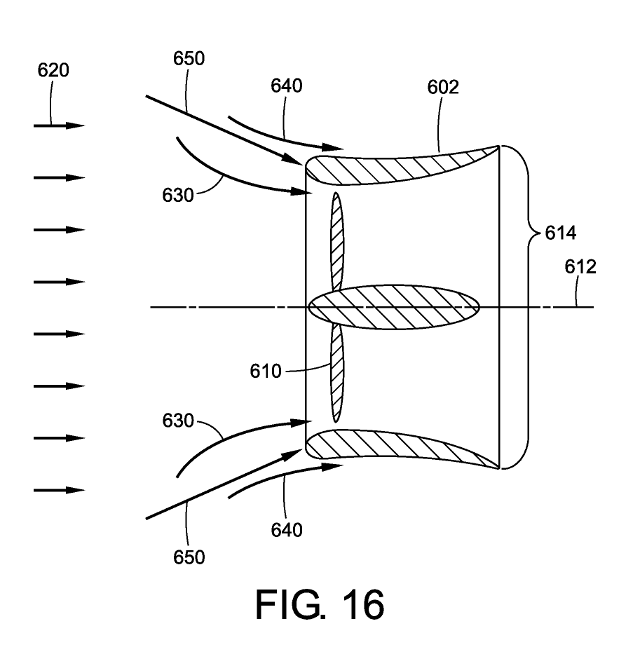

FIG. 16 is a side cross-sectional view of a turbine shroud 602. This shroud does not have mixing lobes. The impeller 610 is shown here as a propeller, and is located along centerline 612. Compared to the diffuser of FIG. 1, the exit area 614 is smaller. Free air 620 approaching the turbine is separated into an interior airstream 630 and an exterior airstream 640. A stagnant airstream 650 separates the two airstreams, and indicates the angle of attack.

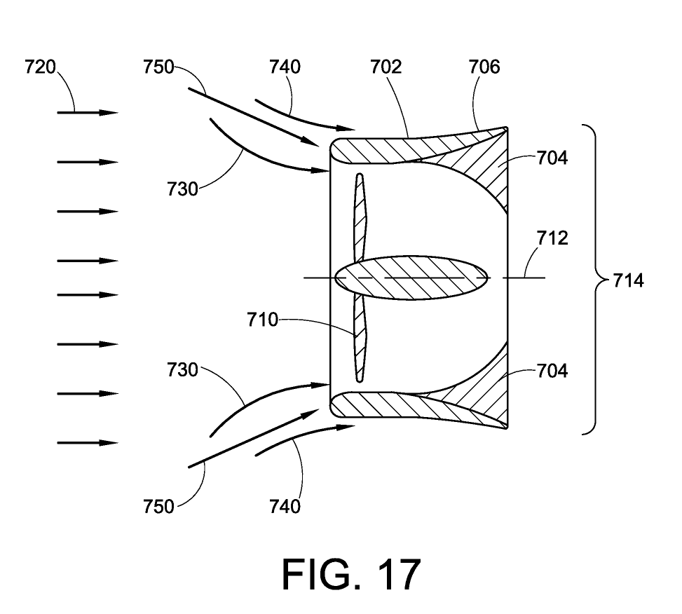

FIG. 17 is a side cross-sectional view of a turbine shroud 702 that has mixing lobes along the trailing edge, and an exit area 714. The high-energy mixing lobe is indicated with reference numeral 704, while the low-energy mixing lobe is indicated with reference numeral 706. The impeller 710 is located along centerline 712. Free air 720 approaching the turbine is separated into an interior airstream 730 and an exterior airstream 740. A stagnant airstream 750 separates the two airstreams, and indicates the angle of attack.

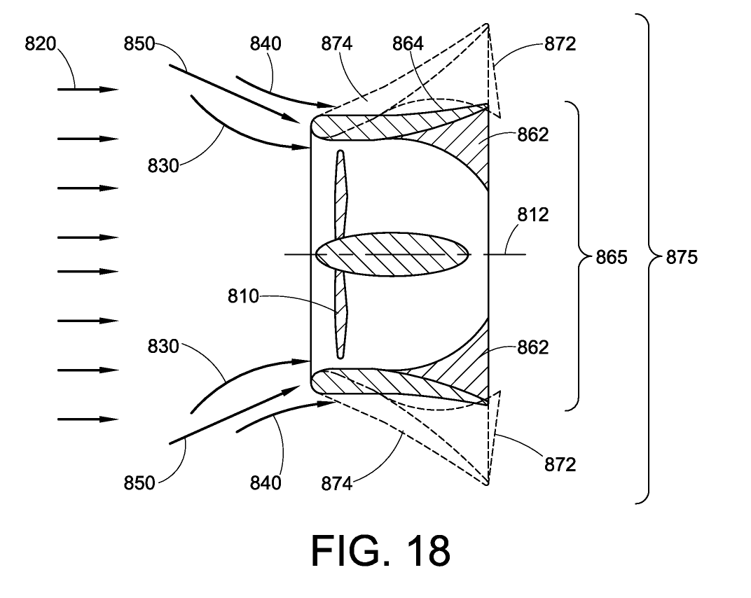

FIG. 18 is a side cross-sectional view of a turbine shroud that has mixing lobes along the trailing edge, and which can change its shape to change the angle of attack. The impeller 810 is located along centerline 812. Free air 820 approaching the turbine is separated into an interior airstream 830 and an exterior airstream 840. A stagnant airstream 850 separates the two airstreams, and indicates the angle of attack. Two angles of attack are shown here. The first angle of attack is indicated with the high-energy mixing lobe 862 and the low-energy mixing lobe 864, in solid lines. The second angle of attack is indicated with the high-energy mixing lobe 872 and the low-energy mixing lobe 874, in dotted lines. The second angle of attack is greater than the first angle of attack, as indicated by the difference in their exit areas, 865 for the first angle of attack and 875 for the second angle of attack.

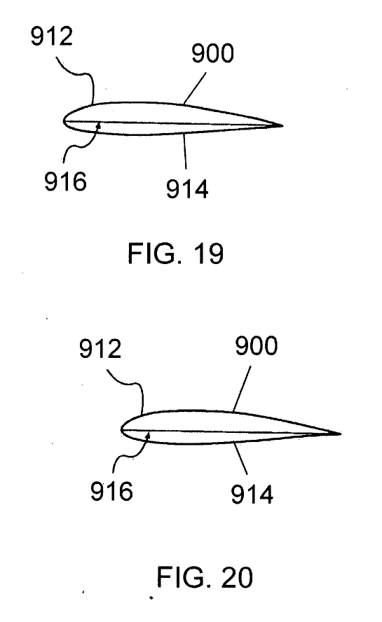

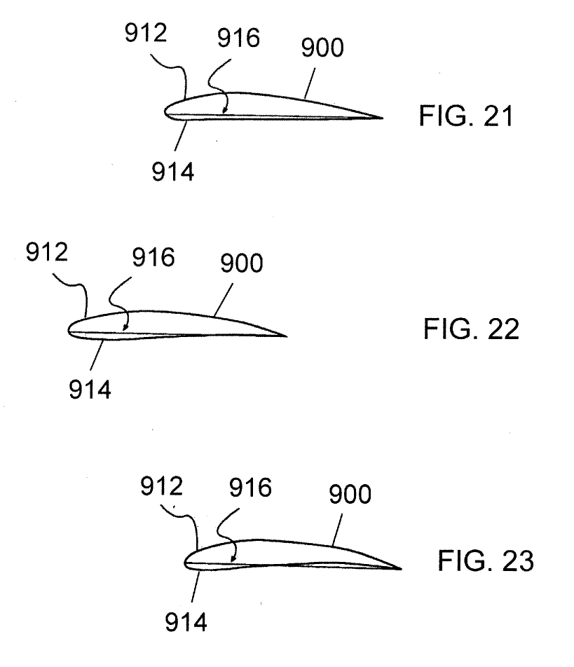

FIGS. 19-23 show airfoils having different camber, with the oncoming airstream coming from the left. Each airfoil 900 has an upper surface 912, a lower surface 914, and a chord line 916. FIG. 19 has positive camber, as reflected by the chord line 916 being located entirely within the upper surface 912 and the lower surface 914. The depicted airfoils show a change in the location of the lower surface, as indicated by the chord line 916 moving to the outside of the lower surface 914.

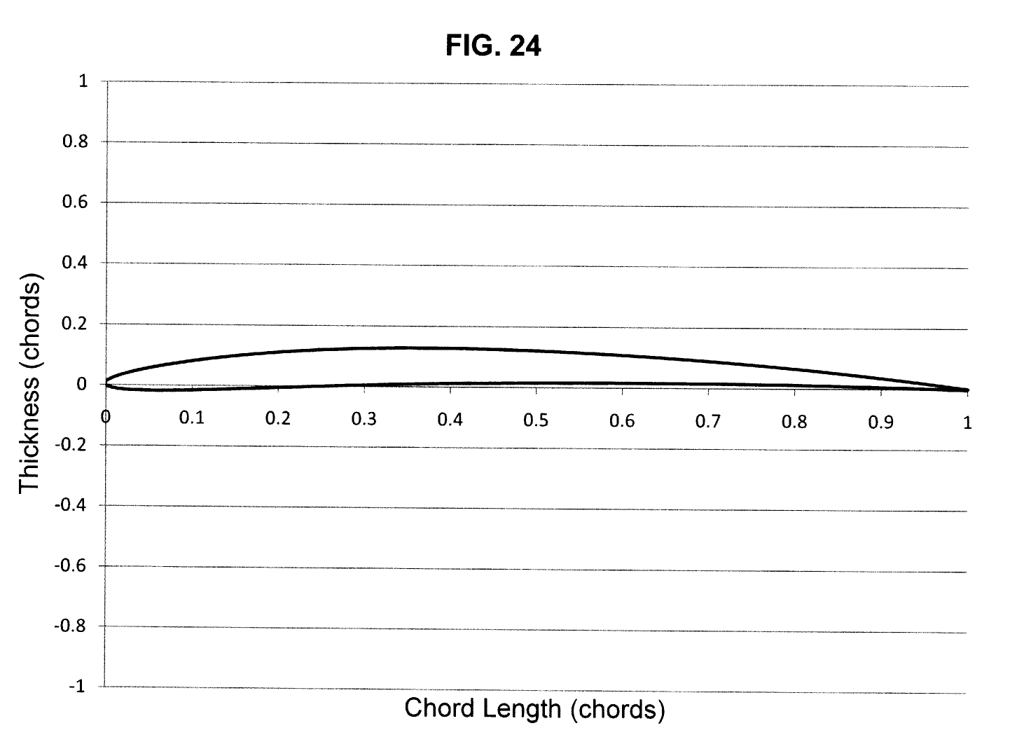

In specific embodiments, the turbine shroud or the ejector shroud have a NACA 7412 airfoil shape. Again, the upper surface of the airfoil shape is on the interior of the shroud, so that the higher wind velocity over the upper surface passes through the impeller. The NACA 7412 is a 4-digit series airfoil having a maximum camber of 7% of the chord (0.07 chords) at a location 40% of the chord (0.4 chords) from the leading edge, and a maximum thickness of 12% of the chord. FIG. 24 is a graph showing the cross-section of the NACA 7412 airfoil. Please note the values are normalized by the length of the chord line. In other embodiments, both the turbine shroud and the ejector shroud have an airfoil shape corresponding to a NACA 7412 airfoil.

Referring to FIG. 11, the ejector shroud 428 does not have mixing lobes, and so the airfoil cross-section remains the same around the entire circumference of the ejector shroud. In other words, when the ejector shroud is cut in half by a plane passing through the central axis, the two airfoil cross-sections will always look the same. However, when mixing lobes are present, such as on the turbine shroud 402, the cross-section will not always appear the same when cut in half by a plane passing through the central axis. In such cases, the cross-section of the low-energy mixing lobe 420 should be considered as providing the airfoil shape of the turbine shroud 402. The cross-section of the high-energy mixing lobe 418 may have a different airfoil shape. This is also reflected in FIG. 17, where for example, the cross-section of low-energy mixing lobe 706 is the NACA 7412 airfoil shape, and the cross-section of high-energy mixing lobe 704 can be a different airfoil shape.

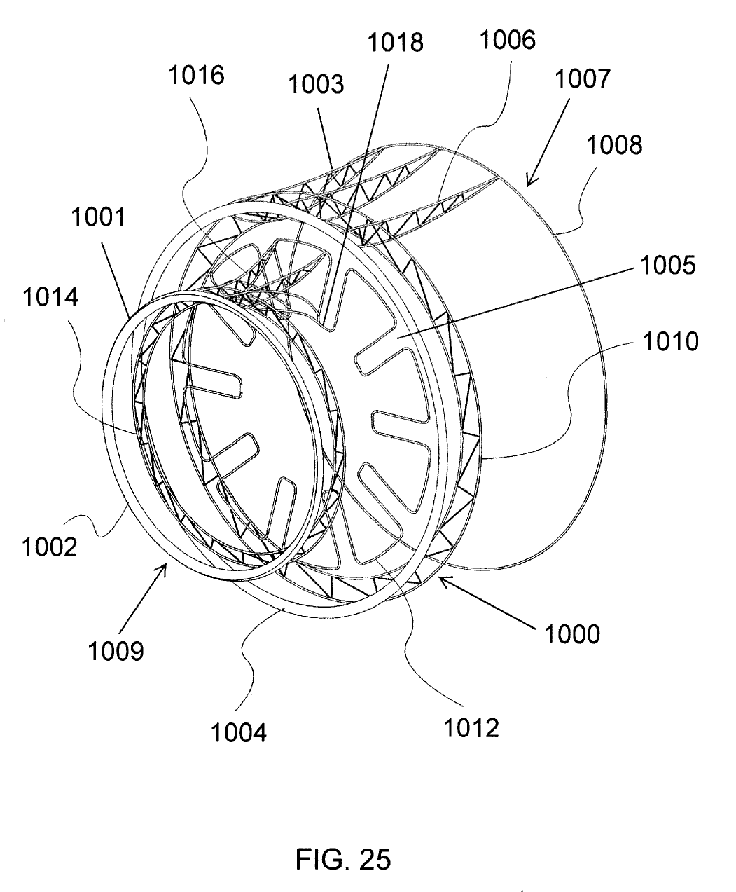

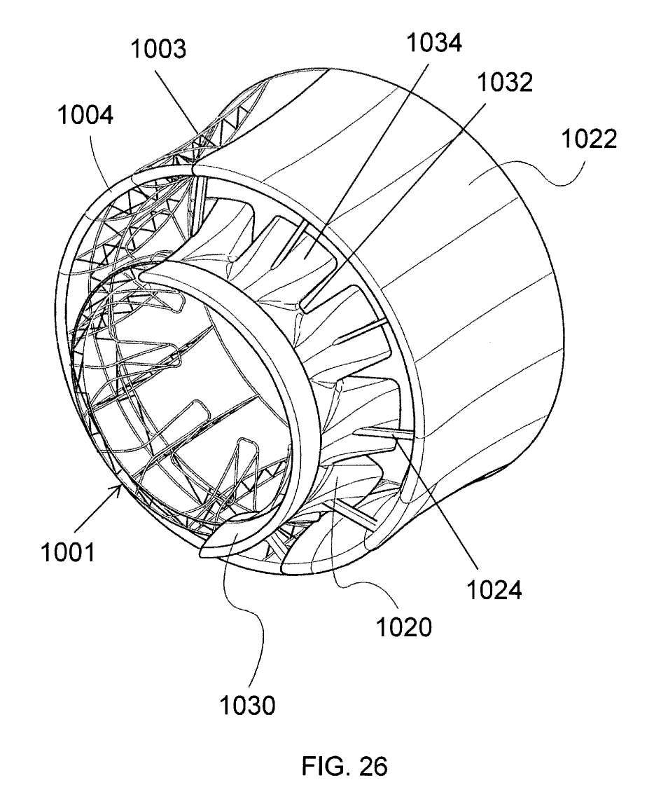

The turbine shroud and the ejector shroud can be composed of a solid material. Alternatively, as shown in FIG. 25 and FIG. 26, the shroud(s) can be made using a lattice structure that incorporates a frame with a coated fabric or film on the outside of the frame. This structure can also be considered a skeleton-and-skin structure.

Here, the turbine shroud skeleton is indicated generally at 1001 and an ejector shroud skeleton is indicated generally at 1003. FIG. 25 shows both skeletons in their partially completed state.

The turbine shroud skeleton 1001 includes a turbine shroud front ring structure or first rigid structural member 1002, a turbine shroud mixing structure or second rigid structural member 1012, and a plurality of first internal ribs 1016. A turbine shroud ring 1014, which may be formed as a truss, may be included to further define the shape of the turbine shroud, as well as provide a connecting point between the turbine shroud skeleton 1001 and the ejector shroud skeleton 1003. When present, the ring truss 1014 is substantially parallel to the turbine shroud front ring structure 1002. A plurality of second internal ribs 1018 may also be used to further define the shape of the mixing lobes. The first rigid structural member 1002, ring truss 1014, and second rigid structural member 1012 are all connected to each other through the first internal ribs 1016 and the second internal ribs 1018. The first rigid structural member 1002 and the second rigid structural member 1012 are generally parallel to each other and perpendicular to the turbine axis.

The turbine shroud front ring structure 1002 defines a front or inlet end 1009 of the turbine shroud skeleton 1001, and a front or inlet end of the overall skeleton 1000. The turbine shroud mixing structure 1012 defines a rear end, exit end, or exhaust end of the turbine shroud skeleton 1001. The turbine shroud front ring structure 1002 defines a leading edge of the turbine shroud.

The second rigid structural member 1012 is shaped somewhat like a gear with a circular crenellated or castellated shape. It should be noted that the crenellated shape may be only part of the second rigid structural member, and that the second rigid structural member could be shaped differently further upstream of the crenellated shape.

The ejector shroud skeleton 1003 includes an ejector shroud front ring structure or first rigid structural member 1004, a plurality of first internal ribs 1006, and a second rigid structural member 1008. Again, an ejector shroud ring 1010, which may be formed as a truss, may be included to further define the shape of the ejector shroud, and provide a connecting point between the turbine shroud skeleton 1001 and the ejector shroud skeleton 1003. When present, the ring truss 1010 is substantially parallel to the ejector shroud front ring structure 1004 and disposed normal to the turbine axis. The first rigid structural member 1004, ring truss 1010, and second rigid structural member 1008 are all connected to each other through the plurality of first internal ribs 1006. The first rigid structural member 1004 and the second rigid structural member 1008 are generally parallel to each other and normal to the turbine axis.

The ejector shroud front ring structure 1004 defines a front or inlet end 1005 of the ejector shroud skeleton 1003. The ejector shroud rear ring structure 1008 defines a rear end, exit end, or exhaust end 1007 of the ejector shroud skeleton 1003. The exhaust end 1007 of the ejector shroud rear ring structure 1008 also defines a rear end, exit end, or exhaust end of the overall skeleton 1000. The ejector shroud front ring structure 1004 defines a leading edge of the ejector shroud. Both the first rigid structural member 1004 and the second rigid structural member 1008 are substantially circular. It should be noted that when the exit end of the turbine shroud is placed in the inlet end of the ejector shroud, an annular area is formed between them.

FIG. 26 illustrates the skeletons with the skin partially applied. A turbine skin 1020 partially covers the turbine shroud skeleton 1001, while an ejector skin 1022 partially covers the ejector shroud skeleton 1003. Support members 1024 are also shown that connect the turbine shroud skeleton 1001 to the ejector shroud skeleton 1003. The support members 1024 are connected at their ends to the turbine shroud ring truss 1014 and the ejector shroud ring truss 1010. The resulting turbine shroud 1030 has two sets of mixing lobes, high energy mixing lobes 1032 that extend inwards toward the central axis of the turbine, and low energy mixing lobes 1034 that extend outwards away from the central axis. The resulting ejector shroud 1040 does not have mixing lobes. However, if desired, the ejector shroud may also include a plurality of ejector shroud second internal ribs, which will allow for the formation of mixing lobes on the ejector shroud as well. Such a structure is directly analogous to the mixing lobes formed on the turbine shroud.

The skin 1020, 1022, respectively, of both the turbine shroud and the ejector shroud may be generally formed of any polymeric film or fabric material. Exemplary materials include polyesters, polyamides, polyolefins, polyurethanes, polyureas, cotton, rayon, polyfluoropolymers, and multi-layer films of similar composition. Stretchable fabrics, such as spandex-type fabrics or polyurethane-polyurea copolymer containing fabrics, may also be employed. Mixtures of fibers of different materials are also contemplated.

Polyurethane films are tough and have good weatherability. The polyester-type polyurethane films tend to be more sensitive to hydrophilic degradation than polyether-type polyurethane films. Aliphatic versions of these polyurethane films are generally ultraviolet resistant as well.

Exemplary polyfluoropolymers include polyvinyldidene fluoride (PVDF) and polyvinyl fluoride (PVF). Commercial versions are available under the trade names KYNAR® and TEDLAR®. Polyfluoropolymers generally have very low surface energy, which allow their surface to remain somewhat free of dirt and debris, as well as shed ice more readily as compared to materials having a higher surface energy.

The skin may be reinforced with a reinforcing material. Examples of reinforcing materials include but are not limited to highly crystalline polyethylene fibers, paramid fibers, and polyaramides. An example of a suitable reinforcing material is high strength polyethylene fibers such as SPECTRA fibers manufactured by Honeywell, which can provide dimensional strength to the skin.

The turbine shroud skin and ejector shroud skin may independently be multi-layer, comprising one, two, three, or more layers. Multi-layer constructions may add strength, water resistance, UV stability, and other functionality. However, multi-layer constructions may also be more expensive and add weight to the overall wind turbine.

The skin may cover all or part of the skeleton; however, the skin is not required to cover the entire skeleton. For example, the turbine shroud skin may not cover the leading and/or trailing edges of the turbine shroud skeleton. The leading and/or trailing edges of either shroud skeleton may be comprised of rigid materials. Rigid materials include, but are not limited to, polymers, metals, and mixtures thereof. Other rigid materials such as glass reinforced polymers may also be employed. Rigid surface areas around fluid inlets and outlets may improve the aerodynamic properties of the shrouds. The rigid surface areas may be in the form of panels or other constructions. Film/fabric composites are also contemplated along with a backing, such as foam.

The skin can also be a hybrid, with a stiff material on the interior of the shroud and a flexible material on the exterior of the shroud. The stiff material can be a fiberglass reinforced plastic (FRP), a carbon fiber composite, sheet metal (aluminum 6061 or the like), or an injection molded panel made from an engineering resin. Exemplary engineering resins include polyphenylene oxide blends or polycarbonate/polybutylene terephalate blends (trade name XENOY).

The skeleton can be produced from a tubular metal, such as aluminum 6061 T6; a tubular polymeric material having the required strength, typically a fiber filled high strength plastic, such as polyphthalamide filled with 40% glass; a strut and wire configuration; or combinations thereof.

It should be understood by those skilled in the art that modifications can be made without departing from the spirit or scope of the disclosure. Accordingly, reference should be made primarily to the appended claims rather than the foregoing description.

1. A shrouded horizontal axis wind turbine, comprising:
an impeller; and
a shroud surrounding the impeller, the shroud having a cross-sectional airfoil shape that generates low pressure inside the shroud, the airfoil shape being selected so that flow separation occurs at a trailing edge of the shroud.

2. The wind turbine of claim 1, wherein the airfoil shape is a NACA 7412 airfoil shape.

3. The wind turbine of claim 1, wherein the shroud further comprises mixing lobes on a trailing edge thereof.

4. The wind turbine of claim 1, wherein the shroud is a turbine shroud, and further comprising an ejector shroud having an inlet end, an exit end of the turbine shroud extending into the inlet end of the ejector shroud.

5. The wind turbine of claim 4, wherein the ejector shroud has a cross-sectional airfoil shape, the airfoil shape being selected so that flow separation occurs at a trailing edge of the ejector shroud.

6. The wind turbine of claim 5, wherein the ejector shroud airfoil shape is a NACA 7412 airfoil shape.

7. The wind turbine of claim 4, wherein the ejector shroud includes mixing lobes on a trailing edge thereof.

8. A shrouded horizontal axis wind turbine, comprising:
an impeller;
a turbine shroud surrounding the impeller, the turbine shroud having a cross-sectional airfoil shape that generates low pressure inside the turbine shroud, the airfoil shape being selected so that flow separation occurs at a trailing edge of the turbine shroud; and
an ejector shroud having an inlet end, wherein an exit end of the turbine shroud extends into the inlet end of the ejector shroud; and
wherein the ejector shroud has a cross-sectional airfoil shape that generates low pressure inside the ejector shroud, the airfoil shape being selected so that flow separation occurs at a trailing edge of the ejector shroud.

9. The wind turbine of claim 8, wherein the turbine shroud airfoil shape is a NACA 7412 airfoil shape.

10. The wind turbine of claim 8, wherein the turbine shroud further comprises mixing lobes on the turbine shroud trailing edge.

11. The wind turbine of claim 8, wherein the ejector shroud airfoil shape is a NACA 7412 airfoil shape.

12. The wind turbine of claim 8, wherein the ejector shroud further comprises mixing lobes on the ejector shroud trailing edge.

13. The wind turbine of claim 8, wherein the turbine shroud airfoil shape is a NACA 7412 airfoil shape, and the ejector shroud airfoil shape is a NACA 7412 airfoil shape.
